(19) United States
(12) Patent Application Publication
(10) Pub. No.: US 2025/0341826 A1
(43) Pub. Date: Nov. 6, 2025

(54) DATA FLOW FAILURE DETECTION USING DATA SIGNIFICANCE RANKING ANALYSIS

(71) Applicant: Saudi Arabian Oil Company, Dhahran (SA)

(72) Inventors: Wed Hussain Alsadah, Saihat (SA); Maram Eida Alsofiani, Dhahran (SA); Turki Abdullah Alkhateeb, Al-Khobar (SA)

(21) Appl. No.: 18/652,188

(22) Filed: May 1, 2024

(51) Int. Cl. G05B 23/02

(52) U.S. Cl. CPC G05B 23/0218

(57) ABSTRACT

Data flow failure detection of an HLDI using a data tag selection based on analysis of the HLDI data tags and identification of most significant subset of data tags. Data tags are analyzed to determine a significance level for each data tag. The data tags may be ranked by significance level, and a subset of the most significant data tags is selected based on a cutoff level. The subset of most significant data tags may be monitored in real-time to determine the health (that is, data flow quality or failure) of the HLDI.

### BACKGROUND

### Field of the Disclosure

The present disclosure generally relates to control of industrial systems. More specifically, embodiments of the disclosure relate to detecting data flow failures in large-scale multi-hierarchal industrial systems.

### Description of the Related Art

Plants and other industrial systems rely on process controllers and sensors for monitor and control of devices, units, and processes. For example, a plant or other industrial system may have a hierarchical structure of controllers and sensors that provide data to automation systems. In some instances, plants may collectively exchange data with each other, with higher level enterprise and central systems, or a combination thereof. Each plant may thus be gathering data readings from different sensors scattered at multiple plants units, processes and, in some cases, other smaller plants in a hierarchical arrangement. Detection of data flow failures in these systems is challenging, especially for wide and deep hierarchical systems.

### SUMMARY

Large-scale multi-hierarchal industrial systems exchange large amounts of data in real-time. The data flows from sensors at the bottom of the hierarchy and is clustered in individual plant units such as such as Programmable Logic Controllers (PLCs) and Remote Terminal Units (RTUs). In turn, the plant units deliver data to a higher level in the hierarchy to plant automation systems such as Distributed Control Systems (DCSs). These hierarchies become wider and deeper with the addition of multiple plants that exchange data with each other and with higher level enterprise and central systems such as Supervisory Control and Data Acquisition (SCADA) Systems. At the top SCADA system level, multiple High-Level Data Interfaces (HLDIs) may retrieve real-time data originating from multiple plants.

Detecting data flow failures at a given HLDI is difficult, especially for wide and deep hierarchical systems. Additionally, checking the health of each and every data reading of an HLDI is inefficient and computationally expensive, and relying on individual data reading to draw conclusions about HLDI health might be misleading and associated with errors. Existing techniques typically monitor an HLDI via monitoring the status of one tag transmitted via the HLDI. However, this approach leads to misleading results and is associated with incorrect HLDI health indications; as an HLDI delivers real-time data from multiple plants, evaluating the performance using a single data reading may be misleading. Moreover, the real-time data flow of one data tag may fail due to failure/degradation in the HLDI as well as various other reasons beyond the HLDI such as instrumentation failure, the exceeding of range limits, local operational changes, data tag reading that becomes out of service, problems in plant local data interfaces, issues with a plant local data management system, etc.

Another technique is to monitor all the data received via the HLDI. However, this approach is computationally expensive and may suffer from the same problems as the single data tag approach discussed supra. Yet another technique may randomly select few tags to represent the HLDI traffic and only monitor the randomly selected tags. However, such random selection might lead to selecting out-of-service tags, bad tags, inactive tags, or tags that are nonsignificant in the process. Moreover, although static flatline readings for multiple sensors located at different plants or units may indicate the presence of a technical issue, such situations may take a relatively long time for control room operators to recognize.

Embodiments of the disclosure are directed to data flow failure detection of an HLDI using a data tag selection based on statistical analysis of the HLDI data streams and identification of most significant subset of tags. Embodiments of the disclosure further include a periodic (for example, weekly) evaluation of the HLDI data tags to ensure the most significant tags are selected. Advantageously, embodiments of the disclosure avoids consideration of data tags that become nonsignificant as they become out-of-service, under maintenance, Test & Inspection (T&I), etc., and introduces recent significant tags in the data flow failure detection process. In normal operational situations, the selected significant tags may reflect the natural process variations and random noise involved in measurements. Moreover, embodiments of the disclosure may identify situations where the most significant HLDI tags are all experiencing unhealthy or static flatline readings that could indicate a data flow failure.

In one embodiment, a method for detecting a data flow failure in a High-Level Data Interface (HLDI) is provided. The method includes obtaining a plurality of values of a respective plurality of data tags from the HLDI, each of the plurality of data tags corresponding to a measurement device from an industrial process, the plurality of values having historical values of the respective plurality of data tags over a time period at a sample rate. Additionally, the method includes determining a respective plurality of significance levels for the plurality of data tags based on the plurality of values, ranking the plurality of data tags by the respective plurality of significance levels, selecting a subset of the highest ranked data tags from the ranked plurality of data tags based on a cutoff level, such that, the cutoff level defines a number of data tags in the subset, and obtaining a plurality of current values for the respective subset of highest ranked data tags. The method also includes determining a data flow value, which includes multiplying each of the plurality of current values by a quality flag to determine a plurality of products and summing the plurality of products to produce the data flow value. The method further includes determining a monitored data flow value by subtracting a moving average of the data flow value from a current data flow value and identifying a data flow failure in the HLDI based on a determination of the calculation value equal to zero.

In some embodiments, determining a respective plurality of significance levels for the plurality of data tags based on the plurality of values includes using a random forest algorithm. In some embodiments, the moving average is a 5-day moving average. In some embodiments, the cutoff value is 5. In some embodiments, the time period is 8 hours. In some embodiments, the measurement device includes a pressure sensor, a temperature sensor, or a flowrate sensor. In some embodiments, the method includes providing an indication of the health of the HLDI to a human machine interface of a process automation system (PAS) based on the identification of the data flow failure in the HLDI.

In another embodiment, a non-transitory computer-readable storage medium having executable code stored thereon detecting a data flow failure in a High-Level Data Interface (HLDI). The executable code has a set of instructions that causes a processor to perform operations that include obtaining a plurality of values of a respective plurality of data tags from the HLDI, each of the plurality of data tags corresponding to a measurement device from an industrial process, the plurality of values having historical values of the respective plurality of data tags over a time period at a sample rate. Additionally, the operations include determining a respective plurality of significance levels for the plurality of data tags based on the plurality of values, ranking the plurality of data tags by the respective plurality of significance levels, selecting a subset of the highest ranked data tags from the ranked plurality of data tags based on a cutoff level, such that, the cutoff level defines a number of data tags in the subset, and obtaining a plurality of current values for the respective subset of highest ranked data tags. The operations also include determining a data flow value, which includes multiplying each of the plurality of current values by a quality flag to determine a plurality of products and summing the plurality of products to produce the data flow value. The operations further include determining a monitored data flow value by subtracting a moving average of the data flow value from a current data flow value and identifying a data flow failure in the HLDI based on a determination of the calculation value equal to zero.

In some embodiments, determining a respective plurality of significance levels for the plurality of data tags based on the plurality of values includes using a random forest algorithm. In some embodiments, the moving average is a 5-day moving average. In some embodiments, the cutoff value is 5. In some embodiments, the time period is 8 hours. In some embodiments, the measurement device includes a pressure sensor, a temperature sensor, or a flowrate sensor.

In another embodiment, a process automation system (PAS) is provided, the system includes a data processing system having a processor and a non-transitory computer-readable memory accessible by the processor and having executable code stored thereon. The executable code has a set of instructions that causes a processor to perform operations that include obtaining a plurality of values of a respective plurality of data tags from the HLDI, each of the plurality of data tags corresponding to a measurement device from an industrial process, the plurality of values having historical values of the respective plurality of data tags over a time period at a sample rate. Additionally, the operations include determining a respective plurality of significance levels for the plurality of data tags based on the plurality of values, ranking the plurality of data tags by the respective plurality of significance levels, selecting a subset of the highest ranked data tags from the ranked plurality of data tags based on a cutoff level, such that, the cutoff level defines a number of data tags in the subset, and obtaining a plurality of current values for the respective subset of highest ranked data tags. The operations also include determining a data flow value, which includes multiplying each of the plurality of current values by a quality flag to determine a plurality of products and summing the plurality of products to produce the data flow value. The operations further include determining a monitored data flow value by subtracting a moving average of the data flow value from a current data flow value and identifying a data flow failure in the HLDI based on a determination of the calculation value equal to zero.

In some embodiments, determining a respective plurality of significance levels for the plurality of data tags based on the plurality of values includes using a random forest algorithm. In some embodiments, the moving average is a 5-day moving average. In some embodiments, the cutoff value is 5. In some embodiments, the time period is 8 hours. In some embodiments, the measurement device includes a pressure sensor, a temperature sensor, or a flowrate sensor. In some embodiments, the data processing system is a Supervisory Control and Data Acquisition (SCADA) server.

### BRIEF DESCRIPTION OF THE DRAWINGS

FIG. 1 is a schematic diagram of a multi-hierarchical industrial process system and a process automation system (PAS) that includes a data analytics engine in accordance with embodiments of the disclosure;

FIG. 2 is a flowchart of a process for data flow failure detection in accordance with an embodiment of the disclosure;

FIG. 3 is a flowchart for performing a dataset significance analysis in accordance with an embodiment of the disclosure;

FIG. 4 is a process for performing data flow quality monitoring in accordance with an embodiment of the disclosure; and

FIG. 5 is a block diagram of a data processing system in accordance with an embodiment of the disclosure.

### DETAILED DESCRIPTION

The present disclosure will be described more fully with reference to the accompanying drawings, which illustrate embodiments of the disclosure. This disclosure may, however, be embodied in many different forms and should not be construed as limited to the illustrated embodiments. Rather, these embodiments are provided so that this disclosure will be thorough and complete, and will fully convey the scope of the disclosure to those skilled in the art.

Embodiments of the disclosure include processes, computer-readable media, and systems for detecting data flow failure in an HLDI. Embodiments of the disclosure may analyze data tags and determine a significant level for each data tag. The data tags may be ranked by significance level, and a subset of the most significant data tags is selected based on a cutoff level. The subset of most significant data tags may be monitored in real-time to determine the health (that is, data flow quality or failure) of the HLDI. As used herein, the term “data tag” is equivalent and may be used interchangeably with the terms “tags,” “PI tags,” “data readings,” and “data points.” As used herein, the term “HLDI” may refer to a PI-to-PI interface, a PI-OPC interface, or other interfaces in the context of a process automation system (PAS) that transmit real-time data tags from one computer node to another computer node.

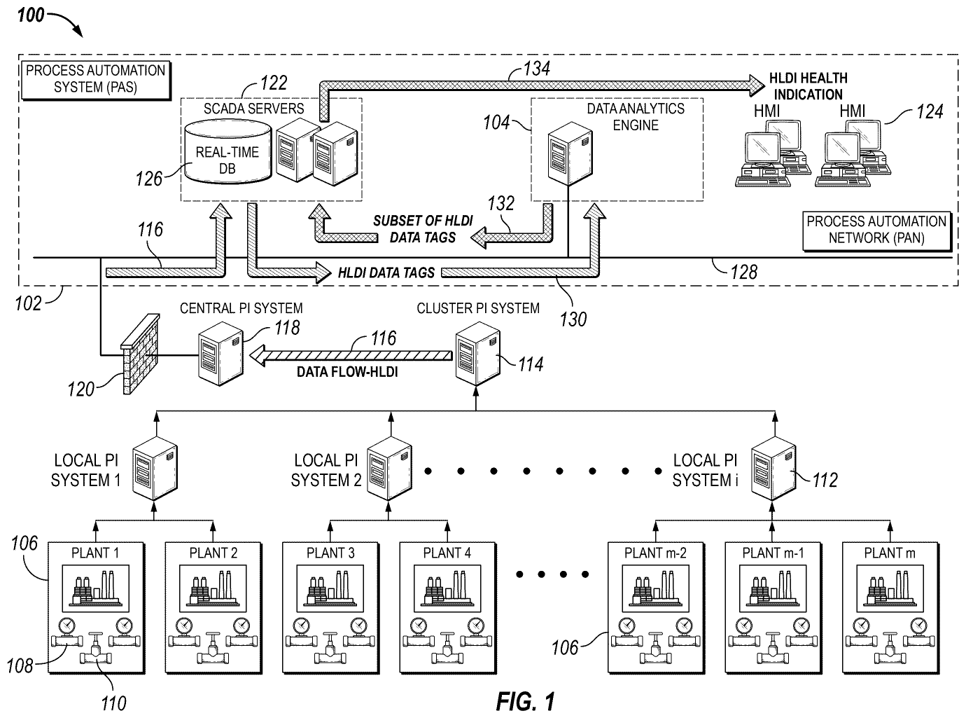

FIG. 1 depicts a multi-hierarchical industrial process system 100 and a process automation system (PAS) 102 that includes a data analytics engine 104 in accordance with embodiments of the disclosure. As discussed in the disclosure, the data analytics engine 104 may obtain the data of the data streams received from one or more High-Level Data Interfaces (HLDIs), determine a data significance and ranking, identify a subset of the most significant data tags, and communicate the identified most significant data tags for data flow quality monitoring by one or more SCADA servers.

The multi-hierarchical industrial process system 100 depicted in FIG. 1 includes a hierarchical structure having multiple levels and in which data may be communicated up-level and down-level from different devices and systems. The multi-hierarchical industrial process system 100 may include multiple plants 106, with each plant 106 having one or more sensors 108, and instruments (for example, valves 110).

The next level of the hierarchy includes local data management systems (for example, local PI systems 112). The local PI systems 112 may perform data exchange and archiving with the plants 106. As shown in FIG. 1, each local PI system 112 may communicate with one or more plants 106. As shown in FIG. 1, in some embodiments, the data management systems may be AVEVA PI Systems™ manufactured by AVEVA Group Plc of Cambridge, England, UK. In other embodiments, the data management systems may be other data exchange and archiving systems, such as Open Platform Communications (OPC)-based systems and interfaces.

In some embodiments, the data from the local PI systems 112 may be collected by a cluster data management system (for example, cluster PI system 114). The cluster PI system 114 may communicate with all of the local PI systems 112 and provide a centralized system for collection and communication of the data the local PI systems 112. Here again, in some embodiments, the cluster data management system may be an AVEVA PI System™ manufactured by AVEVA Group Plc of Cambridge, England, UK. In other embodiments, the cluster data management system may be other data exchange and archiving systems, such as an Open Platform Communications (OPC)-based system and interface.

The multi-hierarchical industrial process system 100 includes an HLDI 116 that communicates data from the cluster PI system 114 to a central data management system (for example, central PI system 118). Here again, in some embodiments, the central data management system may be an AVEVA PI System™ manufactured by AVEVA Group Plc of Cambridge, England, UK. In other embodiments, the central data management system may be other data exchange and archiving systems, such as an Open Platform Communications (OPC)-based system and interface. It should be appreciated that although FIG. 1 is depicting with respect to a single HLDI, embodiments to the disclosure may detect data flow failures in multiple HLDIs using the techniques described herein.

As shown in FIG. 1, in some embodiments, a firewall 120 may be used between the multi-hierarchical industrial process system 100 and the process automation system (PAS) 102. The PAS may include Supervisory Control and Data Acquisition (SCADA) servers 122, the data analytics engine 104, and human machine interfaces 124. The SCADA servers 122 may include or have access to a database 126. In some embodiments, the data analytics engine 104 may be a part of the SCADA servers 122 or, as shown in FIG. 1, the data analytics engine 104 may be implemented in a separate data processing system. The components of the PAS 102 may communicate over a process automation network (PAN) 128.

The PAS 102 may receive HLDI data streams 130 from the HLDI 116 via the central data management system 118 and the firewall 120. The SCADA servers 122 may receive the HLDI data streams 122 and, in some embodiments, data (for example, values) from the data streams 122 may be stored in the database 128. For example, historical data for the HLDI data streams 122 may be stored for a designated time period, such as 2 hours, 4 hours, 6 hours, 8 hours, 10 hours, etc.

As mentioned supra, the process automation system (PAS) 102 may include a data analytics engine 104 that may mine the data of the data streams received from HLDIs, determine a data significance and ranking, identify a subset of the most significant data tags, and communicate the identified most significant data tags. As shown in FIG. 1, the data analytics engine 104 may receive HLDI data streams 130 from the SCADA servers 122. After identifying the subset of the most significant data tags from the HLDI data streams 130, the most significant data tags subset 132 may be communicated to the SCADA servers 122.

The SCADA servers 122 may receive the most significant data tags subset 132. In some embodiments, the SCADA servers 122 may communicate an HLDI health indication 134 to the HMIs 124.

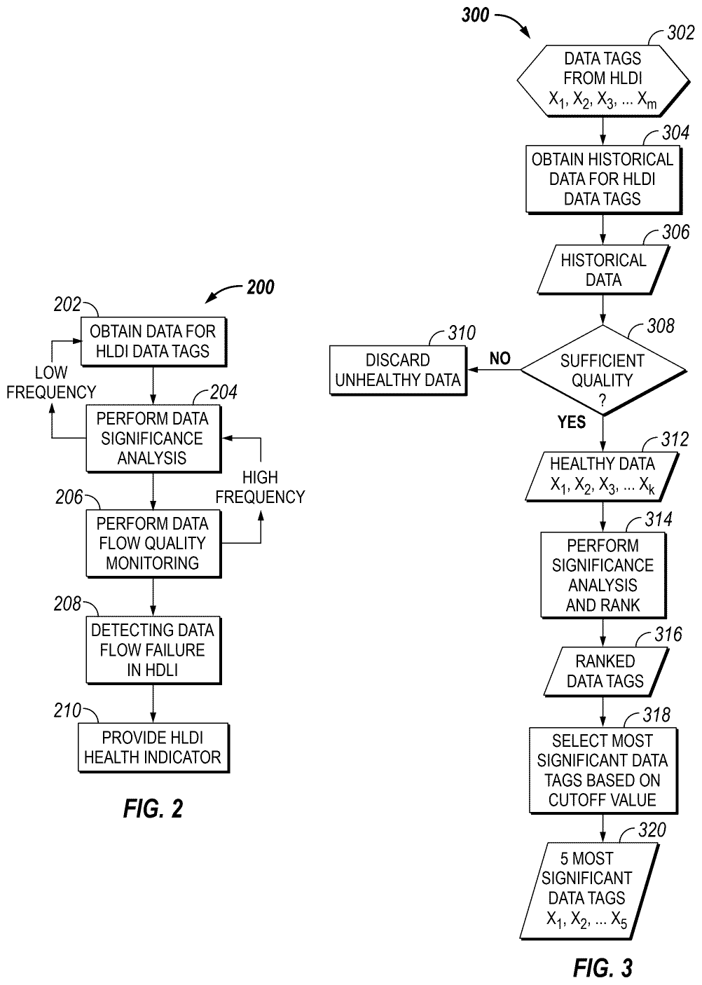

FIG. 2 depicts a process 200 for data flow failure detection in accordance with an embodiment of the disclosure. The process 200 includes obtaining historical data (that is, values) for the HLDI data tags (block 202) of a multi-hierarchical industrial system. As discussed in the disclosure, the HDLI data tags may correspond to sensors and instruments in plants in the multi-hierarchical industrial system; the data may thus correspond to measurements obtained by these sensors and instruments. As will be appreciated, the HLDI data tags typically communicate data at a sample rate. The collected data may be store over a time period to generate historical data.

As shown in FIG. 2, the process 200 includes performing a dataset significance analysis (block 204) using the data (that is, values) for the HLDI data tags. The dataset significance analysis (block 204) is depicted in FIG. 3 and discussed infra. The result of the dataset significance analysis is a subset of most significant HLDI data tags. As also shown in FIG. 2, the dataset significance analysis may be performed at a relatively low frequency as compared to the data flow quality monitoring. In some embodiments, the dataset significance analysis (block 204) is performed weekly (once per week). In other embodiments, the dataset significance analysis may be performed twice a week, three times a week, once every two weeks, once every three weeks, or monthly.

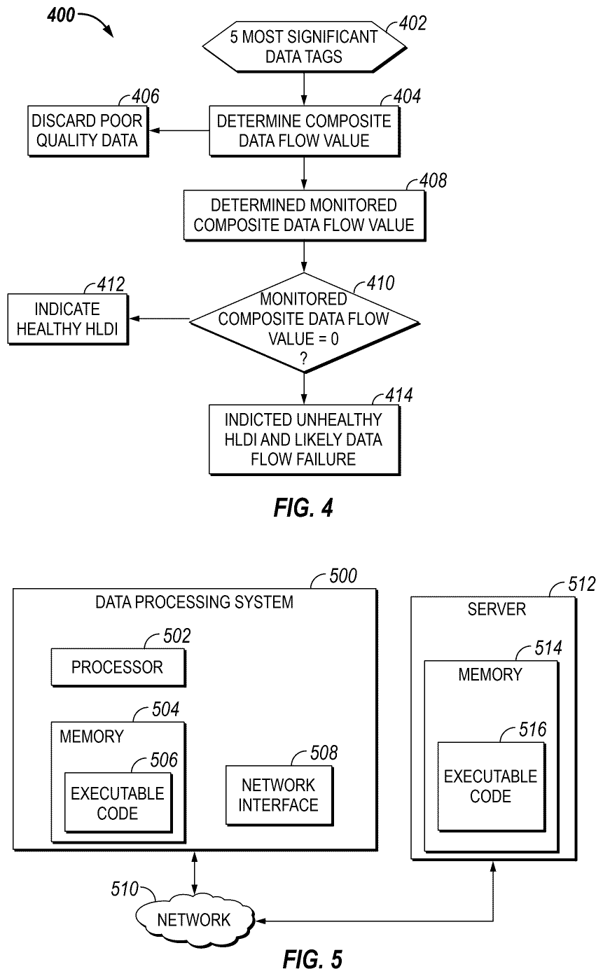

Next, data flow quality monitoring may be performed (block 206) using real-time current values for the subset of most significant data tags. The data flow quality monitoring (block 206) is depicted in FIG. 4 and discussed infra. Current values (as opposed to the historical data used in the dataset significance analysis) for these data tags may be received from the HLDI and monitored in real-time according to the techniques described in the disclosure. As shown in FIG. 2, the data flow quality monitoring may be performed at a relatively high frequency as compared to the dataset significance analysis. In some embodiments, the data flow quality monitoring is performed every 15 seconds. In other embodiments, the data flow quality monitoring may be performed every 10 seconds, every 20 seconds, every 30 seconds, every minute, every two minutes, or every three minutes or greater.

Based on the data flow quality monitoring, a data flow failure in the HLDI may be detected (block 208) using the techniques described in the disclosure. If the data flow failure is detected, an HLDI health may be provided (block 210). For example, in some embodiments an HLDI health indicator may be provided as to an HMI (for example, HMI 124 of FIG. 1), such as alert or notification on a user interface, for viewing and acknowledgement by an operator of a multi-hierarchical industrial system. The indicator may alert the operator to a data flow failure in the HLDI, enabling repair or replacement of the HLDI or further investigation.

FIG. 3 depicts a process 300 for performing a dataset significance analysis (block 202 of FIG. 2) in accordance with an embodiment of the disclosure. Initially, HLDI data tags of an HLDI may be selecting for use in the analysis (block 302). As discussed in the disclosure, the HLDI data tags may correspond to sensors and instruments of industrial plants and may provide corresponding data (for example, pressure, temperature, flowrate) to a PAS via the HLDI. The data tags may be notated as x₁, x₂, x₃, . . . Xm.

Next, historical data (that is values) of the HLDI data streams may be obtained (block 304) from a database of stored data for the HDLI data tags (for example, database 126 of FIG. 1 of or accessible by the SCADA servers 122). In some embodiments, 8 hours of history may be obtained, although other embodiments may obtain at least 2 hours of historical data, at least 4 hours of historical data, at least 6 hours of historical data, or up to 10 hours of historical data. For example, using the notation described supra, each xᵢ for i∈[1,m] may be a column having 8 hours of data (that is, values) sampled every minute for a total of 481 samples.

The historical data (block 306) may be evaluated to determine if the data is of sufficient quality (block 308). Data that is of insufficient quality may be discarded from further processing as unhealthy data (block 310). In some embodiments, determining if data is of sufficient quality may include checking a quality flag added by the PAS to data, such data tags or values flagged as low or bad quality are discarded; calculating the variance of each value from historical data, such that values with zero variance are discarded as the values indicate freezing over time; verifying values that are relatively low based on a configurable threshold (for example points whose mean is less than 1 as this may indicate sensors that are shutdown).

Only the remaining data tags having the healthy data (block 312) may be used in further processing. The healthy data tags (block 312) may be notated as x₁, x₂, x₃, . . . xₖ.

Next, as shown in FIG. 3, a significance analysis and ranking may be performed (block 314) on the healthy data (block 312). In some embodiments, the significance analysis is a random forest significance analysis. In such embodiments, the random forest significance analysis may use a RandomForestRegressor function to calculate the importance of features based on the data (that is, values) for x₁, x₂, x₃, . . . xₖ and determine the significance level for each data tag. In some embodiments, the RandomForestRegressor function is the RandomForestRegressor function is the sklearn.ensemble.RandomForestRegressor function from the scikit-learn library.

In some embodiments, the significant analysis with a random forest may be performed by looping through the healthy data tags as x₁, x₂, x₃, . . . xₖ for k iterations according to the following steps. For a given iteration “i”:
1. The variable xᵢ is considered as a response variable while the rest of the variables are considered as features (predictors);
2. A model “i” is built to predict xᵢ by as x₁, x₂, x₃, . . . xᵢ−1, xᵢ+1, xᵢ1+2, . . . xₖ using a RandomForestRegressor function;
3. The feature importances attribute of the model “i” obtained by the RandomForestRegressor function is used. This provides a list of features x₁, x₂, x₃, . . . xᵢ−1, xᵢ+1, xᵢ+2, . . . xₖ with figures corresponding to their importance score; and
4. For each variable (features), the scores are aggregated.

Upon completing the loop, each variable xᵢ may act as a response variable for 1 time and act as a feature (predictor) for “k−1” times. The importance score for the “k−1” times is accumulated to determine a figure representing the variable overall importance. A list of the healthy “k” variables is generated with their overall importances. This list is ranked by the importance figure to provides the ranked data.

The data tags x₁, x₂, x₃, . . . xₖ may then be ranked by significance level to determine ranked data tags (block 316). After ranking, a subset of the most significant data tags is selected based on a cutoff value for the ranked data tags (block 318). In the embodiment depicted in FIG. 3, the cutoff value is 5, such that the top 5 most significant data tags (notated as x₁, x₂, . . . x₅) (block 320) according to the significance level ranking are selected. In other embodiments, the cutoff value may be 2, 3, 4, 6, 7, 8, 9, or 10.

FIG. 4 depicts a process 400 for performing data flow quality monitoring (block 206) in accordance with an embodiment of the disclosure. The data flow quality monitoring is used to detect data flow failure in an HLDI. The data flow quality monitoring may include obtaining the subset of most significant data tags (block 402) from the dataset significance analysis. In the embodiment depicts in FIGS. 3 and 4, the cutoff value is 5 such that the top 5 most significant data tags (x₁, x₂, . . . x₅) are obtained.

Next, a composite data flow value (also referred to as a “calculation tag”) is determined using the current data (that is, values) for the most significant data tags subset (block 404). The current value for each tag is obtained and multiplied by a binary quality flag (such that 1=healthy and 0=unhealthy), and the products for all the most significant data tags subset are summed to calculate the composite data flow value, according to the following:

$$X = {\sum }_{1}^{p = 5} {x}_{p} * Quality ( {x}_{p} ) \qquad ( 1 )$$

where x is the composite data value, xₚ is the data tag value, and Quality (xₚ) is the quality flag. In such embodiments, the binary quality flag may be identified by the SCADA servers. The determination of the composite data flow value thus results in the discarding of poor quality data (quality flag=0) (block 406), as the data tag will be multiplied by zero and will not contribute to the summed composite data flow value.

As shown in FIG. 4, the process 400 includes determining a monitored composite data flow value (block 408) by subtracting a moving average of the composite data flow value from the real-time current composite data flow value. The moving average may be obtained from the historical data (that is values) of the HLDI data tags, such as from a database of stored data for the HDLI data tags. In some embodiments, the moving average is a 5 minutes moving average, such that the monitored composite data flow value is as follows:

$$Z = X - {MVA}_{5 min} ( X ) \qquad ( 2 )$$

where Z is the monitored composite data flow value and MVA₅ₘᵢₙ(X) is the 5 minutes moving average. In other embodiments, the moving average may be calculated for different time periods, such as 2 minutes, 3 minutes, 4 minutes, or 6 minutes or greater.

The monitored composite data flow value is evaluated for a zero or nonzero value (block 410). If the value is nonzero, the monitored composite data flow value indicates healthy HLDI data (block 412), as significant data tag values are being received and new values from the HLDI are being updated. In contrast, if the monitored composite data flow value is zero, this indicates unhealthy HLDI data and likely data flow failure (block 414), as a zero result indicates that all data are flagged as unhealthy (that is, all readings are multiplied by zero) or that none of the significant data tags provided any changes in values for the past continuous time period of the moving average (for example, for the past continuous 5 minutes for a 5 minutes moving average). In some embodiments, healthy or unhealthy flag indication may be generated for the HLDI and used by a PAS for notifications, alerts, etc.

FIG. 5 depicts a data processing system 500 that includes a processor 502 and memory 504 coupled to the processor 502 to store operating instructions, control information and database records therein in accordance with an embodiment of the disclosure. The data processing system 500 may be a multicore processor with nodes such as those from Intel Corporation or Advanced Micro Devices (AMD), or an HPC Linux cluster computer. The data processing system 500 may also be a mainframe computer of any conventional type of suitable processing capacity such as those available from International Business Machines (IBM) of Armonk, N.Y., or other source. The data processing system 500 may in some cases also be a computer of any conventional type of suitable processing capacity, such as a personal computer, laptop computer, or any other suitable processing apparatus. The data processing system 500 may also be representative of resources available in a computer cluster or a cloud-computing platform. It should thus be understood that a number of commercially available data processing systems and types of computers may be used for this purpose.

The data processing system 500 includes executable code 506 stored in non-transitory memory 504 of the data processing system 500. The executable code 506 according to the present disclosure is in the form of computer operable instructions causing the data processor 502 to receive input data and provide outputs based on processing the input data. The computer operable instructions of the executable code 506 may thus define the data analytics engine 104 and a data significance analysis as discussed in the disclosure.

The executable code 506 may be in the form of microcode, programs, routines, or symbolic computer operable languages capable of providing a specific set of ordered operations controlling the functioning of the data processing system 500 and direct its operation. The instructions of executable code 506 may be stored in memory 504 of the data processing system 500, or on computer diskette, magnetic tape, conventional hard disk drive, electronic read-only memory, optical storage device, or other appropriate data storage device having a non-transitory computer readable storage medium stored thereon.

The data processing system 500 may include a network interface 508 for communication over a network 510 (for example, a process automation network PAN)). The network interface 508 may implement a suitable technology for communication with the network 510, such as Ethernet, Wi-Fi, or other technologies.

The data processing system 500 may be in communication with a server 512 (for example, a second data processing system referred to as a “server”). The server 512 may also include a memory 514 having executable code 516 stored therein. For example, the executable code 516 of the server 512 may define a database and a data flow quality monitoring process in accordance with the embodiments of the disclosure.

### EXAMPLES

The following examples are included to demonstrate embodiments of the disclosure. It should be appreciated by those of skill in the art that the techniques and compositions disclosed in the example which follows represents techniques and compositions discovered to function well in the practice of the disclosure, and thus can be considered to constitute modes for its practice. However, those of skill in the art should, in light of the present disclosure, appreciate that many changes can be made in the specific embodiments which are disclosed and still obtain a like or a similar result without departing from the spirit and scope of the disclosure.

An HLDI transmitting real-time data reading from 14 Gas Oil Separation Plants (GOSP's) was evaluated using the techniques described in the disclosure. The data significance analysis identified 5 significant data readings from 3 different GOSPs. The 5 tags were monitored to evaluate the performance of the HLDI. The technique is adaptive in that it may result in a different subset of significant data tags when executed at different weeks and different times of the year. For example, this may be result from a change in operations in which some plants or units may go in to Test & Inspection (T&I) activities, shutdowns, changes in operational modes, out of service changes for instrumentations, etc. The analysis of the HLDI data streams and the identification of the significant data tags was performed once per week. The resulting 5 data tags were used for data flow quality monitoring every 15 seconds according to the techniques described in the disclosure. As discussed supra, a flag about the HLDI was set if the calculation value was “zero”, which would take place when the chosen significant data readings are bad or stop providing data updates for a continuous 5 minute duration.

Tables 1 and 2 shows 8 hours historical data for 40 pressure tags collected from an HLDI that collects data from 14 different GOSPs. The data was analyzed according to the data significance analysis described supra.

TABLE 1
PRESSURE TAGS HISTORICAL DATA

| Sample | Timestamp | PIP1 | PIP2 | PIP3 | PIP4 | PIP5 | PIP6 | . . . |
|---|---|---|---|---|---|---|---|---|
| 1 | 15-Sep-23 | 210.65 | 318.39 | 240.50 | 272.73 | 274.55 | 356.45 | . . . |
| | 00:00:00 | | | | | | | |
| 2 | 15-Sep-23 | 211.86 | 318.51 | 240.50 | 273.95 | 275.76 | 356.30 | . . . |
| | 00:01:00 | | | | | | | |
| 3 | 15-Sep-23 | 212.13 | 318.37 | 240.50 | 276.71 | 278.79 | 356.44 | . . . |
| | 00:02:00 | | | | | | | |
| 4 | 15-Sep-23 | 212.41 | 318.34 | 240.50 | 275.25 | 277.32 | 356.25 | . . . |
| | 00:03:00 | | | | | | | |
| 5 | 15-Sep-23 | 212.30 | 318.44 | 240.50 | 274.55 | 276.19 | 356.17 | . . . |
| | 00:04:00 | | | | | | | |
| 6 | 15-Sep-23 | 211.62 | 318.22 | 240.50 | 275.31 | 276.95 | 356.36 | . . . |
| | 00:05:00 | | | | | | | |
| 7 | 15-Sep-23 | 212.74 | 318.20 | 240.50 | 277.00 | 278.76 | 356.30 | . . . |
| | 00:06:00 | | | | | | | |
| 8 | 15-Sep-23 | 213.04 | 318.42 | 240.50 | 279.93 | 281.76 | 356.54 | . . . |
| | 00:07:00 | | | | | | | |
| 9 | 15-Sep-23 | 215.41 | 318.34 | 240.50 | 279.96 | 281.79 | 356.51 | . . . |
| | 00:08:00 | | | | | | | |
| 10 | 15-Sep-23 | 209.42 | 318.33 | 240.50 | 279.79 | 281.38 | 356.04 | . . . |
| | 00:09:00 | | | | | | | |
| . . . | . . . | . . . | . . . | . . . | . . . | . . . | . . . | . . . |
| 473 | 15-Sep-23 | 189.48 | 314.76 | 240.50 | 264.60 | 266.22 | 352.53 | . . . |
| | 07:52:00 | | | | | | | |
| 474 | 15-Sep-23 | 190.81 | 314.78 | 240.50 | 266.23 | 267.88 | 352.60 | . . . |
| | 07:53:00 | | | | | | | |
| 475 | 15-Sep-23 | 191.16 | 314.70 | 240.50 | 269.77 | 271.19 | 352.95 | . . . |
| | 07:54:00 | | | | | | | |
| 476 | 15-Sep-23 | 195.85 | 314.92 | 240.50 | 268.17 | 269.65 | 352.42 | . . . |
| | 07:55:00 | | | | | | | |
| 477 | 15-Sep-23 | 197.67 | 314.84 | 240.50 | 270.68 | 271.94 | 352.60 | . . . |
| | 07:56:00 | | | | | | | |
| 478 | 15-Sep-23 | 203.14 | 314.92 | 240.50 | 270.41 | 272.06 | 352.40 | . . . |
| | 07:57:00 | | | | | | | |
| 479 | 15-Sep-23 | 207.93 | 314.94 | 240.50 | 272.43 | 274.00 | 352.39 | . . . |
| | 07:58:00 | | | | | | | |
| 480 | 15-Sep-23 | 211.81 | 314.95 | 240.50 | 277.84 | 279.56 | 352.57 | . . . |
| | 07:59:00 | | | | | | | |
| 481 | 15-Sep-23 | 214.60 | 314.81 | 240.50 | 282.99 | 284.81 | 352.57 | . . . |
| | 08:00:00 | | | | | | | |

TABLE 2
PRESSURE TAGS HISTORICAL DATA

| Sample | Timestamp | . . . | PIP35 | PIP36 | PIP37 | PIP38 | PIP39 | PIP40 |
|---|---|---|---|---|---|---|---|---|
| 1 | 15-Sep-23 | . . . | 217.62 | 103.85 | 75.87 | 202.66 | −14.21 | 66.36 |
| | 00:00:00 | | | | | | | |
| 2 | 15-Sep-23 | . . . | 217.52 | 103.76 | 77.22 | 202.64 | −14.21 | 66.25 |
| | 00:01:00 | | | | | | | |
| 3 | 15-Sep-23 | . . . | 217.70 | 103.72 | 79.24 | 202.61 | −14.21 | 65.16 |
| | 00:02:00 | | | | | | | |
| 4 | 15-Sep-23 | . . . | 217.59 | 103.68 | 79.52 | 202.58 | −14.22 | 64.49 |
| | 00:03:00 | | | | | | | |
| 5 | 15-Sep-23 | . . . | 217.58 | 103.63 | 84.46 | 202.56 | −14.22 | 64.47 |
| | 00:04:00 | | | | | | | |
| 6 | 15-Sep-23 | . . . | 217.72 | 103.59 | 79.30 | 202.53 | −14.22 | 64.09 |
| | 00:05:00 | | | | | | | |
| 7 | 15-Sep-23 | . . . | 217.80 | 103.55 | 81.47 | 202.50 | −14.22 | 63.93 |
| | 00:06:00 | | | | | | | |
| 8 | 15-Sep-23 | . . . | 217.62 | 103.50 | 81.98 | 202.48 | −14.25 | 63.31 |
| | 00:07:00 | | | | | | | |
| 9 | 15-Sep-23 | . . . | 217.40 | 103.46 | 79.86 | 202.45 | −14.28 | 60.68 |
| | 00:08:00 | | | | | | | |
| 10 | 15-Sep-23 | . . . | 217.52 | 103.42 | 80.44 | 202.43 | −14.31 | 61.15 |
| | 00:09:00 | | | | | | | |
| . . . | . . . | . . . | . . . | . . . | . . . | . . . | . . . | . . . |
| 473 | 15-Sep-23 | . . . | 217.23 | 104.49 | 78.49 | 203.02 | −14.31 | 63.44 |
| | 07:52:00 | | | | | | | |
| 474 | 15-Sep-23 | . . . | 217.33 | 104.33 | 79.19 | 203.12 | −14.28 | 63.64 |
| | 07:53:00 | | | | | | | |
| 475 | 15-Sep-23 | . . . | 217.29 | 104.17 | 79.17 | 203.23 | −14.24 | 63.47 |
| | 07:54:00 | | | | | | | |
| 476 | 15-Sep-23 | . . . | 217.21 | 104.01 | 77.58 | 203.32 | −14.21 | 63.86 |
| | 07:55:00 | | | | | | | |
| 477 | 15-Sep-23 | . . . | 217.27 | 103.85 | 76.74 | 203.29 | −14.23 | 65.02 |
| | 07:56:00 | | | | | | | |
| 478 | 15-Sep-23 | . . . | 217.50 | 103.71 | 76.57 | 203.26 | −14.24 | 64.79 |
| | 07:57:00 | | | | | | | |
| 479 | 15-Sep-23 | . . . | 217.34 | 103.68 | 80.20 | 203.23 | −14.26 | 65.09 |
| | 07:58:00 | | | | | | | |
| 480 | 15-Sep-23 | . . . | 217.40 | 103.66 | 77.91 | 203.20 | −14.27 | 66.14 |
| | 07:59:00 | | | | | | | |
| 481 | 15-Sep-23 | . . . | 217.36 | 103.64 | 82.33 | 203.17 | −14.29 | 65.31 |
| | 08:00:00 | | | | | | | |

Table 3 shows the results of the data significance analysis and the use of a 5 data tag cutoff value for the most significant data tags identified from the data of Tables 1 and 2. The 5 most significant data tags are identified in bold and are related to 5 different significant process locations. The 5 data tags were provided to the data flow quality monitoring according to the techniques described in the disclosure.

TABLE 3
MOST SIGNIFICANT PRESSURE TAGS

| PI Tag | Significance Rank |
|---|---|
| PIP30 | 0.106068819 |
| PIP2 | 0.08709298 |
| PIP21 | 0.68272831 |
| PIP15 | 0.049650233 |
| PIP35 | 0.048059204 |
| PIP28 | 0.046328596 |
| PIP5 | 0.044809795 |
| PIP4 | 0.044612874 |
| . . . | . . . |

Tables 4 and 5 show 8 hours historical data for 60 flowrate tags collected from an HLDI that collects data from 14 different GOSPs. This example illustrates use of the techniques described in the disclosure to monitor data flow failure of process flows instead of pressures. The data was analyzed according to the data significance analysis described supra.

TABLE 4
FLOW TAGS HISTORICAL DATA

| Sample | Timestamp | PIF1 | PIF2 | PIF3 | PIF4 | PIF5 | PIF6 | . . . |
|---|---|---|---|---|---|---|---|---|
| 1 | 15-Sep-23 | 173.94 | 44.773 | 565.08 | 5E−17 | 167.37 | 355.7 | . . . |
| | 00:00:00 | | | | | | | |
| 2 | 15-Sep-23 | 173.83 | 44.78 | 563.92 | 5E−17 | 167.53 | 355.25 | . . . |
| | 00:01:00 | | | | | | | |
| 3 | 15-Sep-23 | 173.82 | 44.787 | 562.76 | 5E−17 | 167.7 | 354.11 | . . . |
| | 00:02:00 | | | | | | | |
| 4 | 15-Sep-23 | 173.82 | 44.794 | 561.6 | 5E−17 | 167.86 | 358.47 | . . . |
| | 00:03:00 | | | | | | | |
| 5 | 15-Sep-23 | 173.82 | 44.8 | 560.44 | 5E−17 | 167.72 | 361.68 | . . . |
| | 00:04:00 | | | | | | | |
| 6 | 15-Sep-23 | 173.82 | 44.807 | 559.28 | 5E−17 | 167.03 | 360.1 | . . . |
| | 00:05:00 | | | | | | | |
| 7 | 15-Sep-23 | 173.82 | 44.814 | 558.11 | 5E−17 | 167.47 | 360.41 | . . . |
| | 00:06:00 | | | | | | | |
| 8 | 15-Sep-23 | 173.82 | 44.821 | 556.95 | 5E−17 | 166.93 | 359.77 | . . . |
| | 00:07:00 | | | | | | | |
| 9 | 15-Sep-23 | 173.82 | 44.828 | 555.79 | 5E−17 | 166.55 | 357.26 | . . . |
| | 00:08:00 | | | | | | | |
| 10 | 15-Sep-23 | 173.82 | 44.835 | 554.63 | 5E−17 | 159.42 | 337.54 | . . . |
| | 00:09:00 | | | | | | | |
| . . . | . . . | . . . | . . . | . . . | . . . | . . . | . . . | . . . |
| 473 | 15-Sep-23 | 178.76 | 47.09 | 491.68 | 0.00 | 159.06 | 271.03 | . . . |
| | 07:52:00 | | | | | | | |
| 474 | 15-Sep-23 | 178.16 | 47.09 | 495.34 | 0.00 | 158.01 | 280.14 | . . . |
| | 07:53:00 | | | | | | | |
| 475 | 15-Sep-23 | 177.44 | 47.09 | 499.01 | 0.00 | 159.90 | 295.70 | . . . |
| | 07:54:00 | | | | | | | |
| 476 | 15-Sep-23 | 176.73 | 47.09 | 502.68 | 0.00 | 156.08 | 316.74 | . . . |
| | 07:55:00 | | | | | | | |
| 477 | 15-Sep-23 | 176.01 | 47.09 | 512.67 | 0.00 | 157.93 | 318.64 | . . . |
| | 07:56:00 | | | | | | | |
| 478 | 15-Sep-23 | 175.29 | 47.08 | 536.79 | 0.00 | 154.18 | 332.04 | . . . |
| | 07:57:00 | | | | | | | |
| 479 | 15-Sep-23 | 174.58 | 47.08 | 536.71 | 0.00 | 153.47 | 338.84 | . . . |
| | 07:58:00 | | | | | | | |
| 480 | 15-Sep-23 | 173.86 | 47.08 | 536.63 | 0.00 | 155.74 | 347.53 | . . . |
| | 07:59:00 | | | | | | | |
| 481 | 15-Sep-23 | 173.14 | 47.08 | 536.56 | 0.00 | 160.20 | 347.53 | . . . |
| | 08:00:00 | | | | | | | |

TABLE 5
FLOW TAGS HISTORICAL DATA

| Sample | Timestamp | . . . | PIF55 | PIF56 | PIF57 | PIF58 | PIF59 | PIF60 |
|---|---|---|---|---|---|---|---|---|
| 1 | 15-Sep-23 | . . . | 223.45 | 23.56 | 129.19 | 83.36 | 266.82 | 132.83 |
| | 00:00:00 | | | | | | | |
| 2 | 15-Sep-23 | . . . | 206.82 | 20.06 | 101.05 | 84.17 | 270.65 | 134.91 |
| | 00:01:00 | | | | | | | |
| 3 | 15-Sep-23 | . . . | 221.50 | 20.50 | 120.64 | 86.90 | 265.72 | 129.69 |
| | 00:02:00 | | | | | | | |
| 4 | 15-Sep-23 | . . . | 161.50 | 17.48 | 50.18 | 92.14 | 257.87 | 127.16 |
| | 00:03:00 | | | | | | | |
| 5 | 15-Sep-23 | . . . | 199.50 | 18.83 | 120.98 | 98.71 | 250.03 | 118.68 |
| | 00:04:00 | | | | | | | |
| 6 | 15-Sep-23 | . . . | 237.30 | 20.29 | 115.95 | 100.91 | 242.18 | 115.39 |
| | 00:05:00 | | | | | | | |
| 7 | 15-Sep-23 | . . . | 249.36 | 20.23 | 125.47 | 101.89 | 234.33 | 108.02 |
| | 00:06:00 | | | | | | | |
| 8 | 15-Sep-23 | . . . | 225.70 | 20.33 | 107.64 | 98.10 | 226.48 | 90.91 |
| | 00:07:00 | | | | | | | |
| 9 | 15-Sep-23 | . . . | 166.35 | 21.43 | 37.36 | 106.75 | 218.63 | 59.73 |
| | 00:08:00 | | | | | | | |
| 10 | 15-Sep-23 | . . . | 236.62 | 19.09 | 73.94 | 106.02 | 216.02 | 57.70 |
| | 00:09:00 | | | | | | | |
| . . . | . . . | . . . | . . . | . . . | . . . | . . . | . . . | . . . |
| 473 | 15-Sep-23 | . . . | 257.90 | 21.37 | 125.34 | 106.20 | 239.11 | 108.55 |
| | 07:52:00 | | | | | | | |
| 474 | 15-Sep-23 | . . . | 254.83 | 22.78 | 137.42 | 96.60 | 243.00 | 115.37 |
| | 07:53:00 | | | | | | | |
| 475 | 15-Sep-23 | . . . | 239.68 | 24.10 | 135.09 | 86.63 | 246.90 | 123.18 |
| | 07:54:00 | | | | | | | |
| 476 | 15-Sep-23 | . . . | 206.84 | 24.67 | 98.51 | 82.60 | 250.80 | 126.03 |
| | 07:55:00 | | | | | | | |
| 477 | 15-Sep-23 | . . . | 238.74 | 21.98 | 139.85 | 80.96 | 254.69 | 132.57 |
| | 07:56:00 | | | | | | | |
| 478 | 15-Sep-23 | . . . | 176.55 | 11.60 | 71.11 | 83.27 | 258.59 | 135.63 |
| | 07:57:00 | | | | | | | |
| 479 | 15-Sep-23 | . . . | 245.27 | 19.35 | 144.07 | 81.92 | 262.48 | 134.41 |
| | 07:58:00 | | | | | | | |
| 480 | 15-Sep-23 | . . . | 211.86 | 16.89 | 99.40 | 94.98 | 266.38 | 146.02 |
| | 07:59:00 | | | | | | | |
| 481 | 15-Sep-23 | . . . | 241.50 | 17.77 | 132.62 | 94.39 | 270.27 | 139.19 |
| | 08:00:00 | | | | | | | |

Table 6 shows the results of the data significance analysis and the use of a 5 data tag cutoff value for the most significant data tags identified from the data of Tables 4 and 5. Here again, the 5 most significant data tags are related to 5 different significant process locations. The 5 data tags were provided to the data flow quality monitoring to provide an HLDI health indication according to the techniques described in the disclosure.

TABLE 6
MOST SIGNIFICANT FLOW TAGS

| PI Tag | Significance Rank |
|---|---|
| PIF29 | 0.057215257 |
| PIF2 | 0.056017977 |
| PIF24 | 0.054055442 |
| PIF18 | 0.041486298 |
| PIF29 | 0.039631731 |
| PIF44 | 0.036263944 |
| PIF50 | 0.034102581 |
| PIF39 | 0.030096929 |
| . . . | . . . |

Ranges may be expressed in the disclosure as from about one particular value, to about another particular value, or both. When such a range is expressed, it is to be understood that another embodiment is from the one particular value, to the other particular value, or both, along with all combinations within said range.

Further modifications and alternative embodiments of various aspects of the disclosure will be apparent to those skilled in the art in view of this description. Accordingly, this description is to be construed as illustrative only and is for the purpose of teaching those skilled in the art the general manner of carrying out the embodiments described in the disclosure. It is to be understood that the forms shown and described in the disclosure are to be taken as examples of embodiments. Elements and materials may be substituted for those illustrated and described in the disclosure, parts and processes may be reversed or omitted, and certain features may be utilized independently, all as would be apparent to one skilled in the art after having the benefit of this description. Changes may be made in the elements described in the disclosure without departing from the spirit and scope of the disclosure as described in the following claims. Headings used in the disclosure are for organizational purposes only and are not meant to be used to limit the scope of the description.

What is claimed is:

1. A method for detecting a data flow failure in a High-Level Data Interface (HLDI), the method comprising:
obtaining a plurality of values of a respective plurality of data tags from the HLDI, each of the plurality of data tags corresponding to a measurement device from an industrial process, the plurality of values comprising historical values of the respective plurality of data tags over a time period at a sample rate;
determining a respective plurality of significance levels for the plurality of data tags based on the plurality of values;
ranking the plurality of data tags by the respective plurality of significance levels;
selecting a subset of the highest ranked data tags from the ranked plurality of data tags based on a cutoff level, wherein the cutoff level defines a number of data tags in the subset;
obtaining a plurality of current values for the respective subset of highest ranked data tags;
determining a data flow value, the determination comprising:
multiplying each of the plurality of current values by a quality flag to determine a plurality of products; and
summing the plurality of products to produce the data flow value;
determining a monitored data flow value by subtracting a moving average of the data flow value from a current data flow value; and
identifying a data flow failure in the HLDI based on a determination of the calculation value equal to zero.

2. The method of claim 1, wherein determining a respective plurality of significance levels for the plurality of data tags based on the plurality of values comprises using a random forest algorithm.

3. The method of claim 1, wherein the moving average is a 5-day moving average.

4. The method of claim 1, wherein the cutoff value is 5.

5. The method of claim 1, wherein the time period is 8 hours.

6. The method of claim 1, wherein the measurement device comprises a pressure sensor, a temperature sensor, or a flowrate sensor.

7. The method of claim 1, comprising providing an indication of the health of the HLDI to a human machine interface of a process automation system (PAS) based on the identification of the data flow failure in the HLDI.

8. A non-transitory computer-readable storage medium having executable code stored thereon detecting a data flow failure in a High-Level Data Interface (HLDI), the executable code comprising a set of instructions that causes a processor to perform operations comprising:
obtaining a plurality of values of a respective plurality of data tags from the HLDI, each of the plurality of data tags corresponding to a measurement device from an industrial process, the plurality of values comprising historical values of the respective plurality of data tags over a time period at a sample rate;
determining a respective plurality of significance levels for the plurality of data tags based on the plurality of values;
ranking the plurality of data tags by the respective plurality of significance levels;
selecting a subset of the highest ranked data tags from the ranked plurality of data tags based on a cutoff level, wherein the cutoff level defines a number of data tags in the subset;
obtaining a plurality of current values for the respective subset of highest ranked data tags;
determining a data flow value, the determination comprising:
multiplying each of the plurality of current values by a quality flag to determine a plurality of products; and
summing the plurality of products to produce the data flow value;
determining a monitored data flow value by subtracting a moving average of the data flow value from a current data flow value; and
identifying a data flow failure in the HLDI based on a determination of the calculation value equal to zero.

9. The non-transitory computer-readable storage medium of claim 8, wherein determining a respective plurality of significance levels for the plurality of data tags based on the plurality of values comprising using a random forest algorithm.

10. The non-transitory computer-readable storage medium of claim 8, wherein the moving average is a 5-day moving average.

11. The non-transitory computer-readable storage medium of claim 8, wherein the cutoff value is 5.

12. The non-transitory computer-readable storage medium of claim 8, wherein the time period is 8 hours.

13. The non-transitory computer-readable storage medium of claim 8, wherein the measurement device comprises a pressure sensor, a temperature sensor, or a flowrate sensor.

14. A process automation system (PAS), comprising:
a data processing system comprising a processor and a non-transitory computer-readable memory accessible by the processor and having executable code stored thereon, the executable code comprising a set of instructions that causes a processor to perform operations comprising:
obtaining a plurality of values of a respective plurality of data tags from the HLDI, each of the plurality of data tags corresponding to a measurement device from an industrial process, the plurality of values comprising historical values of the respective plurality of data tags over a time period at a sample rate;
determining a respective plurality of significance levels for the plurality of data tags based on the plurality of values;
ranking the plurality of data tags by the respective plurality of significance levels;
selecting a subset of the highest ranked data tags from the ranked plurality of data tags based on a cutoff level, wherein the cutoff level defines a number of data tags in the subset;
obtaining a plurality of current values for the respective subset of highest ranked data tags;
determining a data flow value, the determination comprising:
multiplying each of the plurality of current values by a quality flag to determine a plurality of products; and
summing the plurality of products to produce the data flow value;
determining a monitored data flow value by subtracting a moving average of the data flow value from a current data flow value; and
identifying a data flow failure in the HLDI based on a determination of the calculation value equal to zero.

15. The system of claim 14, wherein determining a respective plurality of significance levels for the plurality of data tags based on the plurality of values comprising using a random forest algorithm.

16. The system of claim 14, wherein the moving average is a 5-day moving average.

17. The system of claim 14, wherein the cutoff value is 5.

18. The system of claim 14, wherein the time period is 8 hours.

19. The system of claim 14, wherein the measurement device comprises a pressure sensor, a temperature sensor, or a flowrate sensor.

20. The system of claim 14, wherein the data processing system is a Supervisory Control and Data Acquisition (SCADA) server.
